(19) United States
(12) Patent Application Publication
(10) Pub. No.: US 2007/0268898 A1
(43) Pub. Date: Nov. 22, 2007

(54) Advanced Routing

(76) Inventors: Ovidiu Ratiu, Marietta, GA (US); Marius Ovidiu Chilom, Mableton, GA (US); Ion Ticus, Bucharest (RO)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/750,028

(22) Filed: May 17, 2007

Related U.S. Application Data
(60) Provisional application No. 60/801,148, filed on May 17, 2006.

(51) Int. Cl. H04L 12/56

(52) U.S. Cl. 370/389

(57) ABSTRACT

Included are embodiments for advanced routing. At least one embodiment of a method includes receiving a message from a first device at a first backbone controller. The message may be configured to indicate a second device as a desired recipient and sending the message to a network controller. The message includes a request to a second backbone controller for a route to the second device, the second backbone controller related to the second device. Some embodiments include receiving the route from the network controller.

### CROSS REFERENCE

This application claims the benefit of U.S. Provisional Application No. 60/801,148, filed May 17, 2006, which is hereby incorporated by reference in its entirety.

### BACKGROUND

In a wireless environment, communication of data across a plurality of devices may be difficult to collaborate with a utilization of network and device efficiency. More specifically, in communicating data from a first device to a second device, a network may utilize one or more other devices to communicate the data to the desired recipient. As such, the one or more other devices may be configured to acknowledge receipt of the data, as well as communicate the data to the next device in the chain.

### SUMMARY

Included are embodiments for advanced routing. In at least one embodiment, a method includes receiving a message from a first device at a first backbone controller. The message is configured to indicate a second device as a desired recipient and sending the message to a network controller. Additionally, the message includes a request to a second backbone controller for a route to the second device, the second backbone controller related to the second device. Some embodiments include receiving the route from the network controller.

Also included are embodiments of a system for advanced routing. At least one embodiment of a system includes a first receiving component configured to receive a message from a first device at a first backbone controller. In some embodiments, the message indicates a second device as a desired recipient. Some embodiments include a sending component configured to send the message to a network controller, the message including a request to a second backbone controller for a route to the second device, the second backbone controller related to the second device. Some embodiments include a second receiving component configured to receive the route from the network controller.

Also included are embodiments of a computer readable storage medium for advanced routing. At least one embodiment includes first receiving logic configured to receive a message from a first device at a first backbone controller. In some embodiments, the message indicates a second device as a desired recipient and sending logic configured to send the message to a network controller. Additionally, the message includes a request to a second backbone controller for a route to the second device, the second backbone controller related to the second device. Some embodiments include second receiving logic configured to receive the route from the network controller.

Other systems, methods, features, and/or advantages of this disclosure will be or may become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

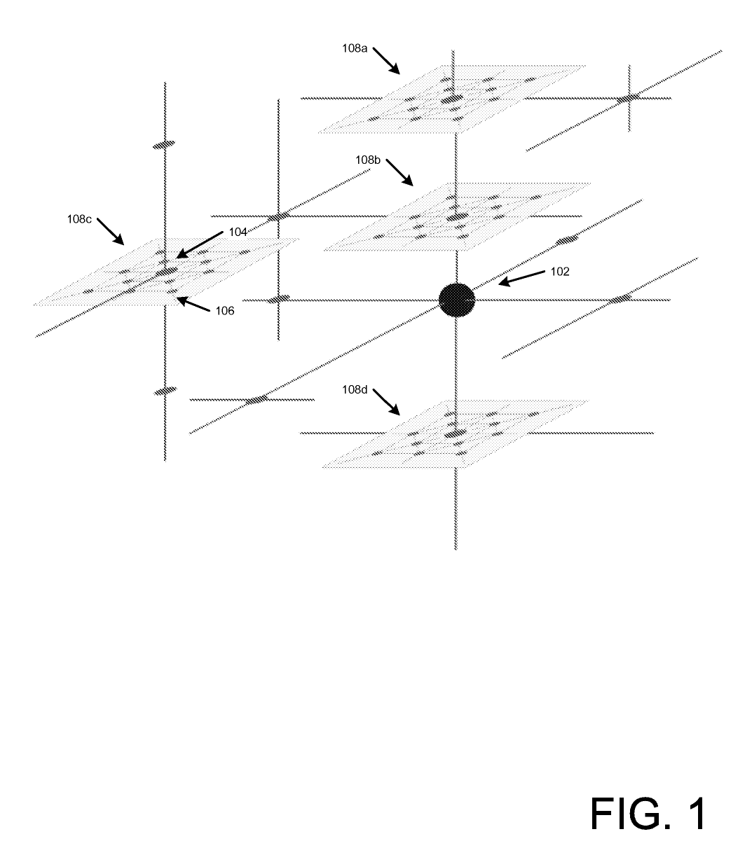

FIG. 1 is an exemplary embodiment of a network section around a concentrator.

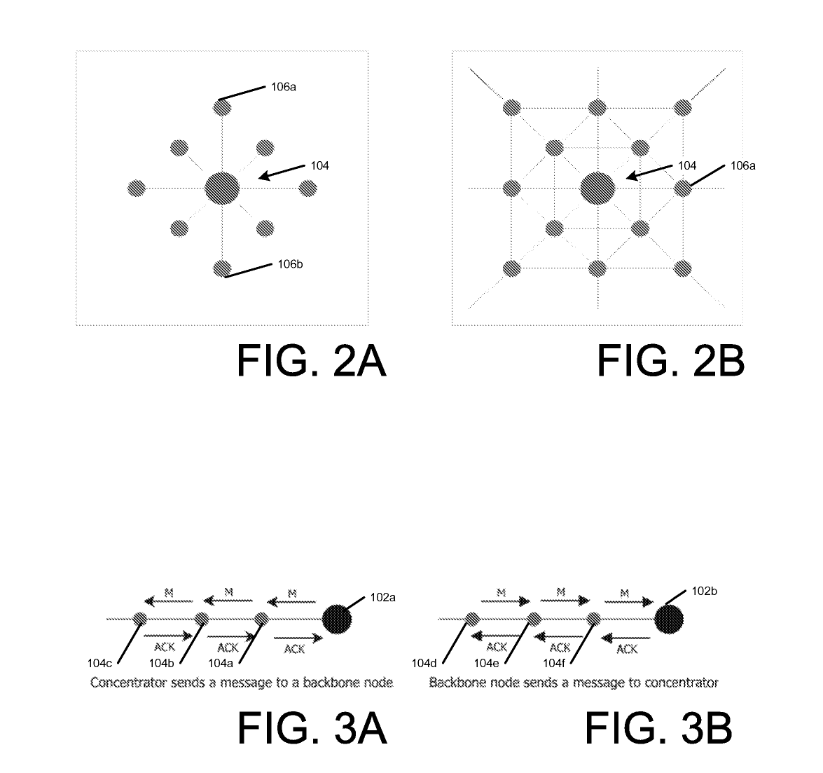

FIG. 2A is a diagram of an exemplary sub-network with a star topology, such as may be utilized in the network from FIG. 1.

FIG. 2B is an exemplary embodiment of a mesh topology sub-networks, similar to the sub-network from FIG. 2A.

FIG. 3A is an exemplary embodiment of a concentrator that sends a message to a backbone node.

FIG. 3B is an exemplary embodiment of a backbone node that sends a message to concentrator.

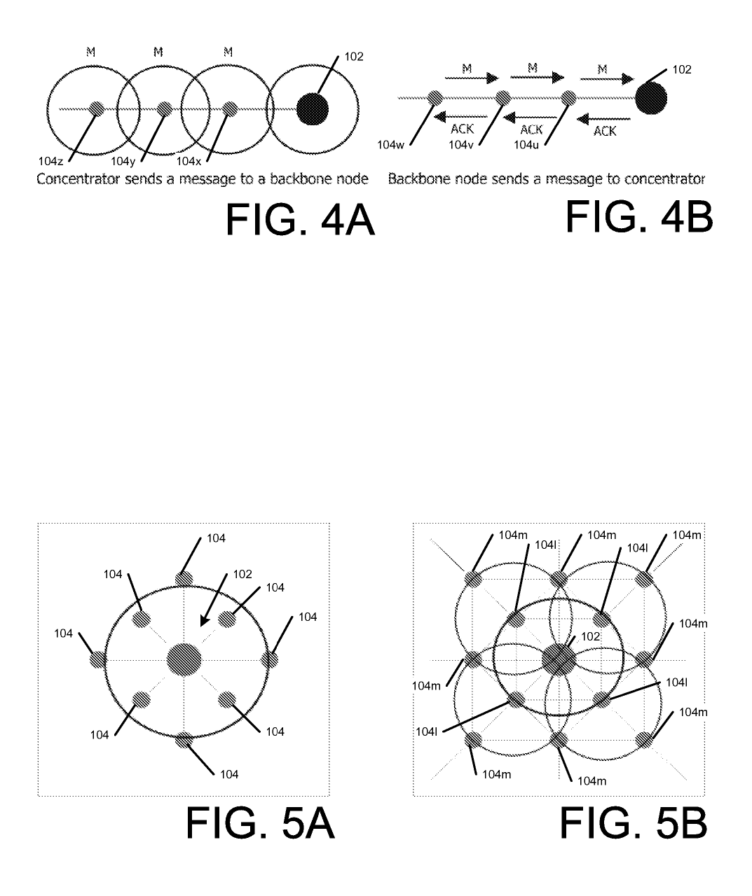

FIG. 4A is an exemplary embodiment of a star topology, illustrating a communication range, similar to the diagram from FIG. 3A.

FIG. 4B is an exemplary embodiment of a mesh topology, illustrating a plurality of communications ranges, similar to the diagram from FIG. 2B.

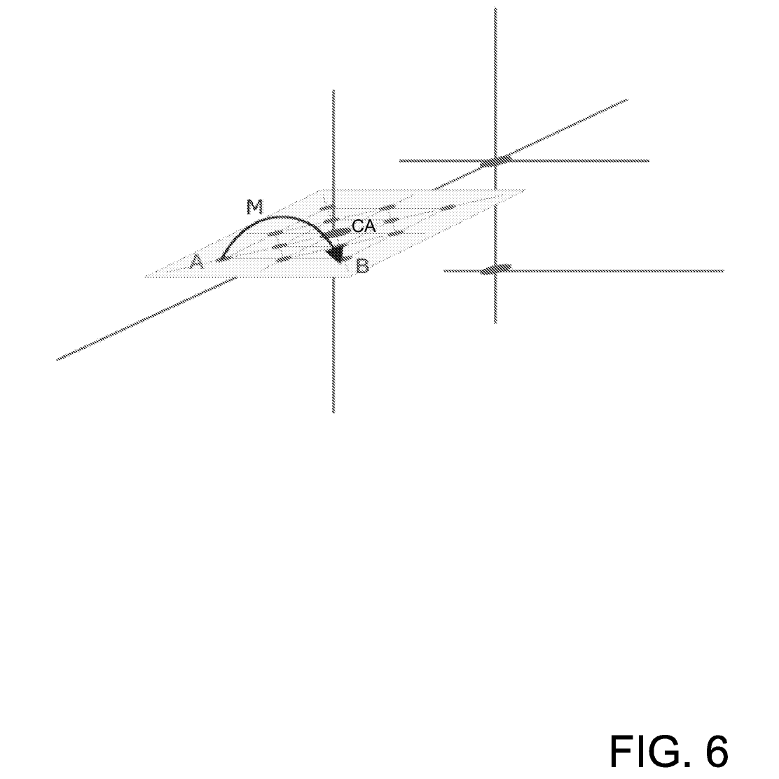

FIG. 5A is an exemplary embodiment of a star topology, illustrating the broadcasting of a message from a concentrator, similar to the diagram from FIG. 4A.

FIG. 5B is an exemplary embodiment of a mesh topology, illustrating the broadcasting of a message from a concentrator, similar to the diagram from FIG. 5A.

FIG. 6 is an exemplary embodiment of a mesh topology, illustrating communication between nodes, similar to the diagram from FIG. 4B.

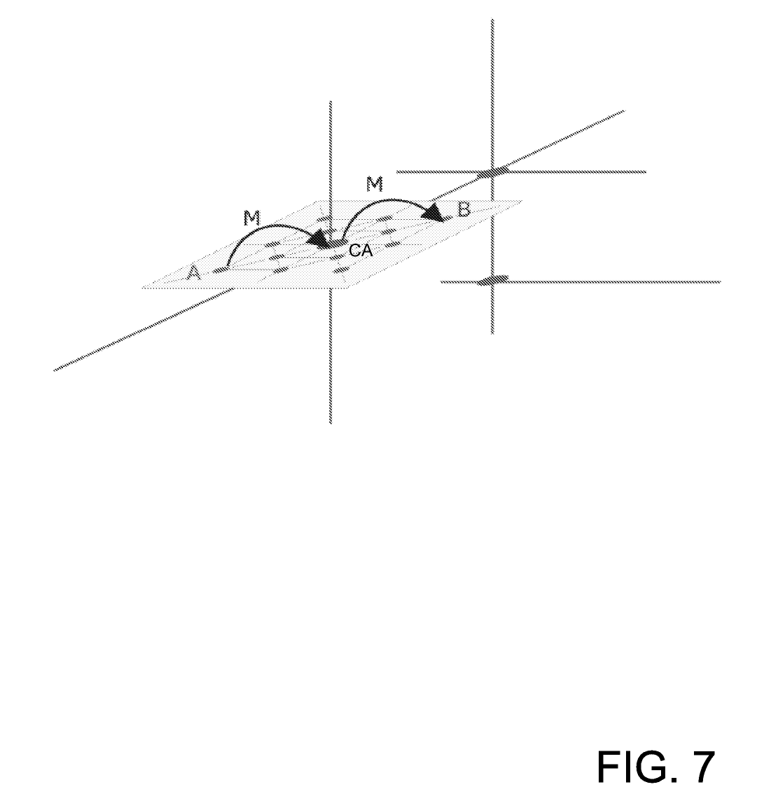

FIG. 7 is an exemplary embodiment of a mesh topology, illustrating communication between nodes, via utilization of a concentrator, similar to the diagram from FIG. 1.

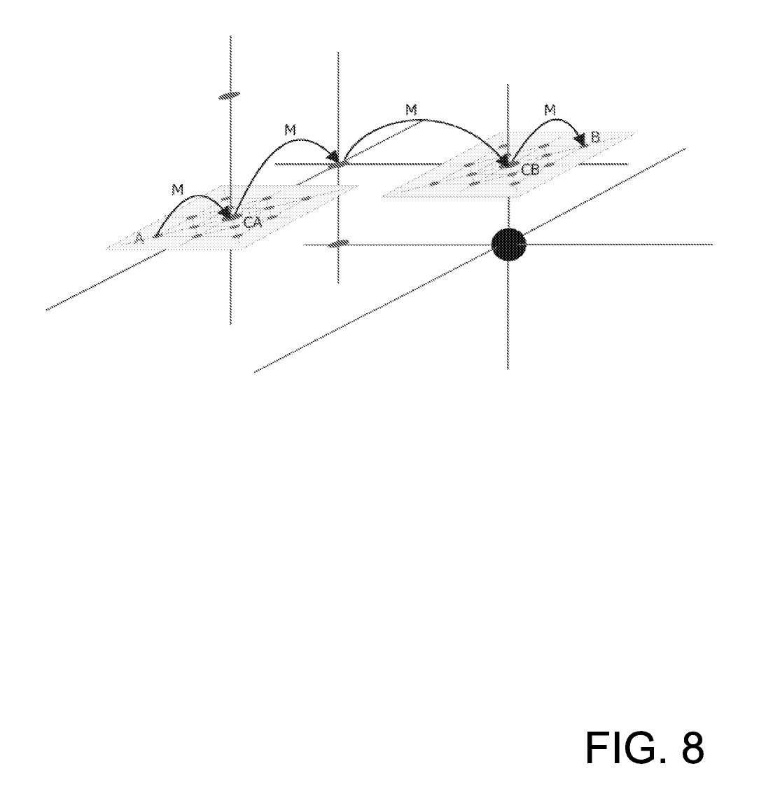

FIG. 8 is an exemplary embodiment of communication of data between a plurality of communication planes, similar to the diagram from FIG. 6.

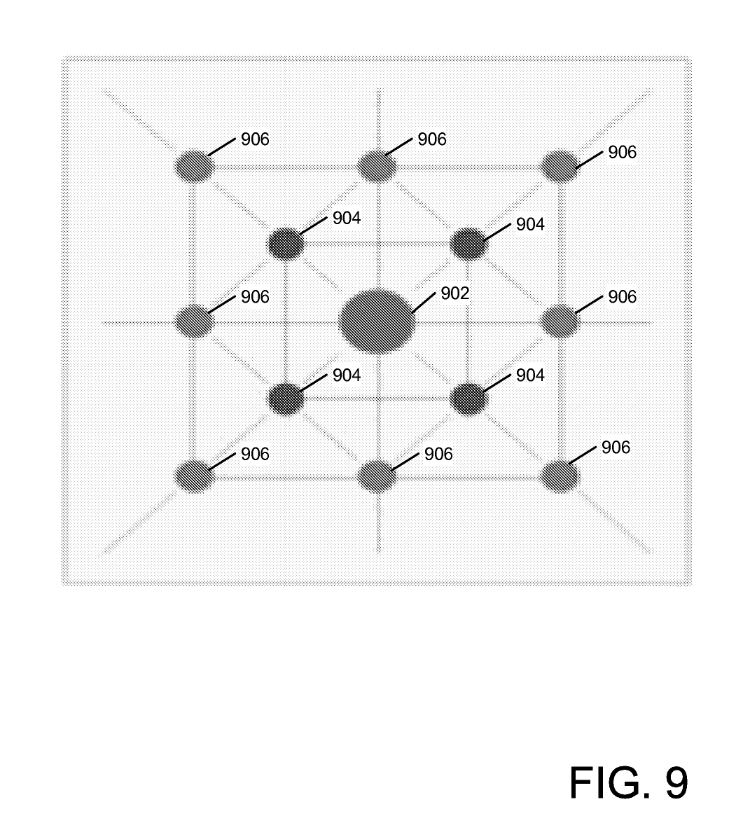

FIG. 9 is an exemplary embodiment of a network plane with a plurality of backbone nodes, similar to the network plane from FIGS. 5A and 5B.

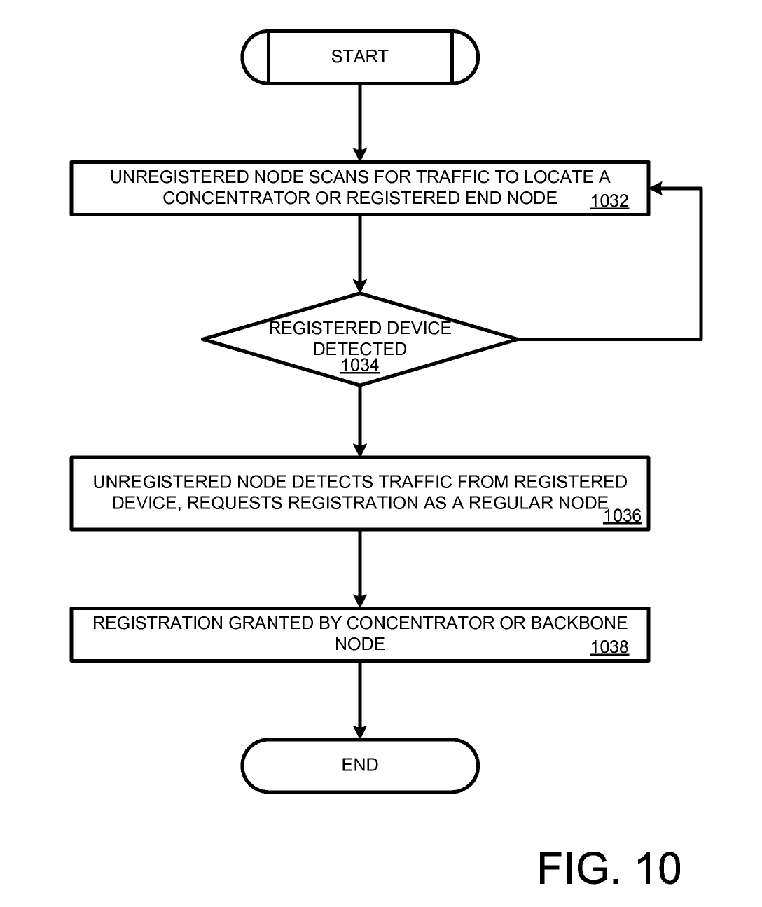

FIG. 10 is an exemplary embodiment of a flowchart that may be utilized in registering a device in a network, such as in the network from FIG. 1.

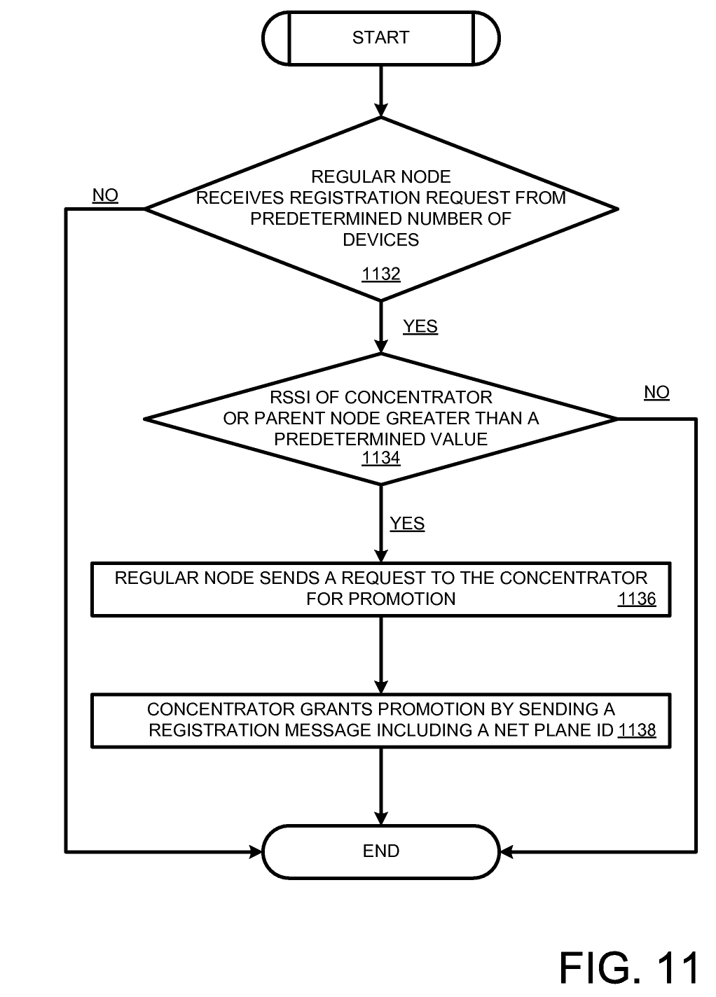

FIG. 11 is an exemplary embodiment of a flowchart that may be utilized in promoting a regular node, similar to the flowchart from FIG. 10.

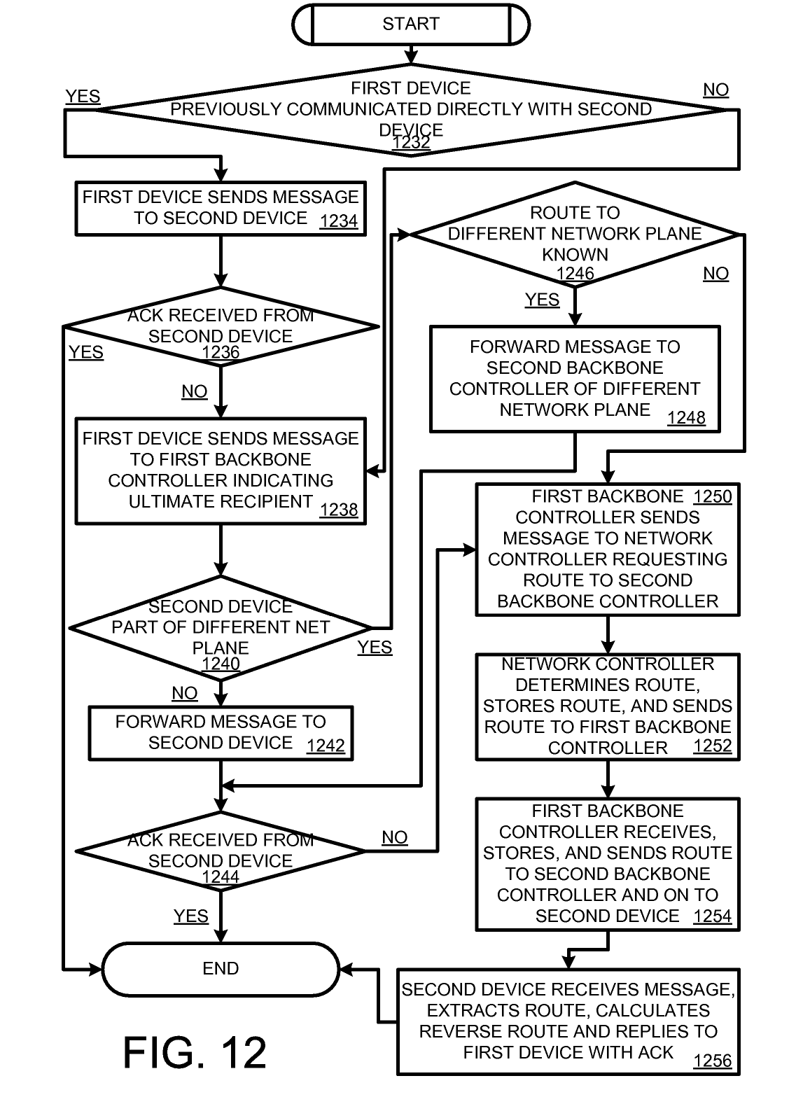

FIG. 12 is an exemplary embodiment of a flowchart that may be utilized in communicating data from a first node to a second node, similar to the flowchart from FIG. 1.

### DETAILED DESCRIPTION

Advanced routing may be configured to define a network of end nodes grouped around concentrators with the purpose of providing two-way communications between the end nodes and the concentrator. The network may be self-configurable and self-healing. Additionally, there may be a plurality of distinct types of end nodes, including regular nodes and backbone nodes, with different features and functionalities. The backbone nodes may be configured to form a stable, reliable communication infrastructure throughout the entire network. The regular nodes may be configured with limited functionality and arrange themselves in network planes around the backbone nodes, using either a star or a mesh topology. The backbone nodes can potentially be further subdivided between main backbone nodes and secondary backbone nodes, the later ones acting as a backup for the first ones. Messages can be exchanged not only between the end nodes and the controller, but also between end nodes without involving the controller, either directly or through hopping along optimally determined routes.

FIG. 1 is an exemplary embodiment of a network section around a concentrator 102. More specifically, as illustrated in FIG. 1, the concentrator 102 may be configured to combine a plurality messages into a single message. Similarly, in at least one exemplary embodiment, the network of FIG. 1 may include one or more end nodes. At least one end node may be included as a backbone node 104. Similarly, at least one end node may be configured as a peer-to-peer backbone node (regular node) 106 around the backbone node 104. Additionally, as illustrated, the end nodes may be configured according to a network plane 108a-108d.

FIGS. 2A-2B are exemplary embodiments of a network planes, such as illustrated in FIG. 1. More specifically, as illustrated in FIG. 2A, a network plane may include a star topology. In a star topology, a backbone node 104 may be surrounded by one or more regular nodes 106. Any of the regular nodes 106a may be configured to communicate with any other regular node 106b, via the backbone node 104.

Similarly, as illustrated in FIG. 2B, a network plane may include a mesh topology. More specifically, in the mesh configuration, the regular end nodes 106 in one plane may be configured to communicate with the corresponding backbone node 104 and with all the other regular end nodes 106 in the same plane. In any configuration, some embodiments may be configured such that the regular end nodes 106 are not configured to communicate with any kind of nodes (regular or backbone) belonging to a different network plane.

FIG. 3A is a diagram illustrating an exemplary embodiment of a sending a message to a backbone node 104, such as in the network from FIG. 1. More specifically, an advanced routing protocol may be utilized that is designed to ensure reliable bidirectional communication between the concentrator 102 and the end nodes 104, 106, while working with an unreliable wireless transport layer.

The backbone of the network may be configured as a peer-to-peer architecture, with messages being relayed from one node to another. Messages that travel through the backbone may be configured to be sent from one device to the next in route, in a peer-to-peer fashion. When a message M is exchanged between two consecutive backbone nodes 104 in a route, a corresponding acknowledgement (ACK) message may also be exchanged to acknowledge the correct reception of the message, as described in more detail below.

More specifically, as illustrated, the concentrator 102 may send a message M for a node 104a. To facilitate this transmission, the concentrator 102 may send the message M to the backbone node 104a. Upon receiving the message M, the backbone node 104a can send an acknowledgement (ACK) back to the concentrator 102a. The backbone node 104a can additionally send the Message M to another backbone node 104b. The backbone node 104b can receive the message M and send an acknowledgment ACK back to the backbone node 104a. The backbone node 104b can then send the message to the destination node 104c. The node 104c can receive the message M and send an acknowledgment back to backbone node 104b.

FIG. 3B is an exemplary embodiment of a backbone node 104 sending a message to a concentrator 102b, similar to the diagram from FIG. 3A. As illustrated, the backbone may be configured to utilize peer-to-peer messages from the backbone nodes 104 to the concentrator 102, using messages that hop from one device to another, along a precisely defined route. As discussed in more detail below, from the concentrator 102b to the backbone nodes 104, the backbone uses broadcast messages. The broadcast messages may differ from the peer-to-peer messages in that they are not sent through a specific route, but they are repeated once by any device that receives them.

More specifically, as illustrated in FIG. 3B, a backbone node 104d can send a message M, which is received by a backbone node 104e. The backbone node 104e can receive the message M and send an acknowledgement (ACK) back to the backbone node 104d. The backbone node 104e can additionally send the message M to a backbone node 104f. The backbone node 104f can receive the message M and send an acknowledgement (ACK) to the backbone node 104e. The backbone node 104f can additionally send the message M to the concentrator 102b. The concentrator 102b can send an acknowledgement (ACK) back to the backbone node 104f.

FIG. 4A is an exemplary embodiment of a star topology, illustrating a communication range, similar to the diagram from FIG. 3A. As illustrated in the nonlimiting example of FIG. 4A, a concentrator 102 may be configured to send a message to a backbone node 104z. The concentrator 102 can achieve this goal by broadcasting a message M across a network (and/or network plane). A backbone node 104x can receive the message M and broadcast the message M. A backbone node 104y can receive the broadcast message M and broadcast the message M, which is received by the desired recipient, backbone node 104z.

FIG. 4B is an exemplary embodiment of a mesh topology, illustrating a plurality of communications ranges, similar to the diagram from FIG. 3B. As illustrated, a backbone node 104w can send a message M, which is received by a node 104v. The node 104v can receive the message M and send an acknowledgement (ACK) back to the backbone node 104w. The node 104v can additionally send the message M to a node 104u. The node 104u can receive the message M and send an acknowledgement (ACK) to the node 104v. The node 104u can additionally send the message M to the concentrator 102. The concentrator 102 can send an acknowledgement (ACK) back to the node 104u.

FIG. 5A is an exemplary embodiment of a star topology, illustrating the broadcasting of a message from a concentrator 102, similar to the diagram from FIG. 4A. As illustrated in the nonlimiting example of FIG. 5A, in a star topology, a concentrator 102 can broadcast a message to a plurality of nodes. Upon receiving the message, the desired recipient can send an acknowledgement (ACK) message back to the concentrator 102. As the desired recipient of the broadcast message may be included in the broadcast range of the concentrator 102, a predetermined message transmission route need not be determined or executed.

FIG. 5B is an exemplary embodiment of a mesh topology, illustrating the broadcasting of a message from a concentrator 102, similar to the diagram from FIG. 5A. As illustrated, in a mesh topology, a concentrator 102 can broadcast a message to a plurality of nodes 1041. After receiving the broadcast message, the one or more of the nodes 1041 can broadcast the received message (and/or a derivation of the received message) to other nodes in the network (or network platform). Upon receiving the message, the desired recipient can send an acknowledgement (ACK) message back to the concentrator 102. By broadcasting a message to a plurality of nodes in a mesh topology, a message transmission route need not be determined or executed.

In the embodiments discussed above, a broadcast message may be repeated a predetermined number of times if no ACK message is received by the message originator within a predefined amount of time. Additionally, if the network plane includes a mesh topology, the regular nodes may repeat the broadcasted message a predetermined number of times. For at least one message transmitted within a network plane, there may be one ACK message sent by the final recipient to the originator of the message. More precisely, if a message is sent from the backbone node 104 to a regular node, then the regular node can send an ACK message to the backbone node. If a regular node sends a message to a backbone node, then the backbone node 104 can send an ACK message to the regular node. If the network plane has a star topology, the receiving regular nodes may be configured to not repeat the broadcasted message, but allow the concentrator 102 (or other message originator) to repeat the broadcast. Regardless of the type of network topology, a broadcast message may be repeated for a configurable number of times if there is no ACK message received by the message originator within a predefined (adjustable) amount of time.

Additionally, embodiments of the advanced routing design disclosed herein may be configured to ensure that the wireless network has self-routing and self-healing capabilities. More specifically, the network may begin to self-organize from the immediate proximity of the concentrator 102 towards the outside. Each end node initially starts in an unregistered state, in which the node scans for traffic, trying to locate a concentrator 102 or a register end node. Once the node detects traffic from registered devices, the node can request registration as a regular node. The registration requests may be sent periodically to all the registered nodes for which traffic is received, in the following order: concentrator 102, backbone nodes 104, in the decreasing order of the Received Signal Strength Indicator (RSSI) value, and regular nodes 106, in the decreasing order of the RSSI value. If there is no traffic from registered devices, the unregistered node takes no action and continues scanning for traffic indefinitely.

Registration can be granted by a concentrator 102 or by a backbone node. Once a device registers as a regular node, it can send and receive messages in the network. A regular node may try to promote itself to a backbone node 104 by sending a request to the concentrator 102 directly and/or through another existing backbone node, called a parent node, if the regular node receives a predefined, configurable number of registration requests from unregistered devices and the RSSI when either the concentrator 102 or the parent node is higher than a predetermined (configurable) value.

The registration as a backbone node 104 may be granted by the concentrator 102. When this happens, the concentrator 102 assigns a network plane ID, which may be communicated to the backbone node 104 in a registration acceptance message. The backbone registration request message carries the ID of the parent node. Based on this information, the concentrator 102 builds and maintains an up-to-date configuration of the entire backbone, storing the complete routes to every backbone node. After registration, all messages originating from a backbone node 104 include the ID of the parent node, thus ensuring that the concentrator 102 always has updated information about the backbone topology. A backbone node 104 can look for an alternative parent node when the link with its current parent node or concentrator 102 becomes unavailable or the RSSI decreases below the threshold value. If there is an alternative parent node available, the backbone node 104 can begin using that parent node. If there is no suitable alternative parent node available, the backbone node 104 can deregister itself. When this happens, at least one of the nodes in the respective network plane deregisters from the network and automatically re-enter the registration process. This ensures the adaptability of the network to changing conditions.

FIG. 6 is an exemplary embodiment of a mesh topology, illustrating communication between nodes, similar to the diagram from FIG. 4B. More specifically, depending on the particular configuration, there can be circumstances where registered nodes can exchange messages between themselves. As a nonlimiting example, a residential electric meter may be installed outside a house and may be configured to send consumption values to a Liquid Crystal Display (LCD) installed inside the house for consumer information purposes. Another possible application would be a temperature sensor sending an on/off command to a Heating Ventilation Air Conditioning (HVAC) unit in proximity when preset high/low temperature thresholds have been met.

Supposing device A needs to send a message M to device B, where A and B are both registered nodes, and A knows the serial number of B. A sends a message directly to B (step 1), only if A has a record of having received traffic directly from B in the past, as shown in the FIG. 6. If A does not perform step 1 or A has not received an ACK message after performing step 1, A sends a message to the backbone controller of its plane CA (step 2), indicating that the ultimate recipient of the message should be B. If CA can identify B as being part of its network plane, it will forward the message to B (step 3), as shown in the FIG. 7.

FIG. 7 is an exemplary embodiment of a mesh topology, illustrating communication between nodes, via utilization of a concentrator 102, similar to the diagram from FIG. 5. As illustrated in FIG. 7, if CA cannot perform step 3 but can find a record of a route to a different network plane that contains B, CA can forward the message to the backbone node CB that controls that network plane using the recorded route and indicating that the ultimate recipient of the message should be B. If CA cannot identify B as being part of its network plane and cannot find a record of a route to a different network plane that contains B, or if CA does not receive an ACK message from B, CA sends a message to the network controller CN requesting a route to the backbone node CB that controls the network plane that contains B. Since the controller CN has updated information about the backbone topology and also has updated information about which regular nodes belong to which network planes, CN can determine an optimal route from CA to CB and sends it to CA, which stores it for future reference. When CA receives a route to CB from CN, CA can store this route for future reference and will forward the message to CB indicating that the ultimate recipient of the message should be B, as shown in the FIG. 8.

As illustrated in FIG. 8, when B receives the message, B can extract the route information embedded in the message, calculate a route back to A by reversing this information and record it for future reference. B can also reply with an ACK message that will be sent through the newly determined route. This mechanism allows nodes from different sections of the network to exchange messages without involving the controller whenever possible, thus optimizing the overall bandwidth usage.

FIG. 9 is an exemplary embodiment of a network plane with a plurality of backbone nodes, similar to the network plane from FIGS. 5A and 5B. As illustrated in this exemplary embodiment, for one or more network plane there can be several backbone nodes, one main backbone node and several secondary backbone nodes, as shown in FIG. 9 where there are 1 main backbone node 902, 4 backup backbone nodes 904, and 8 regular nodes 906. The main backbone node 902 corresponds to the backbone node described above and may be configured to perform similarly. In addition, the secondary backbone nodes 904 may be configured to act as back-ups for situations when the main backbone node fails, being capable of taking over the main backbone node responsibilities and thus avoiding the disintegration of the network plane.

The main backbone node 902 may be configured to issue a regular broadcast message, which may include relevant information for one or more regular nodes members of its network plane. Included in this information are the clock value and the number of nodes in the network plane. Any regular node in a network plane can attempt to promote itself to the status of a secondary backbone node provided the RSSI with the backbone node controlling its own network plane is above a configurable threshold value. Additionally, the regular node can self-promote, if the regular node can receive traffic from a number of nodes in its own network plane that is above a configurable percentage value from the total number of nodes in that network plane. Similarly, a condition for self-promotion may include a determination of whether the regular node can receive traffic from at least one backbone node belonging to another network plane and/or whether the number of already existing secondary backbone nodes in its own network plane has not reached the maximum allowed value. The request for promotion as a secondary backbone node can be sent to the backbone node controlling the network plane, which responds with an acceptance or rejection message.

FIG. 10 is an exemplary embodiment of a flowchart that may be utilized in registering a device in a network, such as in the network from FIG. 1. As illustrated, an unregistered node can scan for traffic to locate a concentrator or registered end node (block 1032). A determination can be made whether a registered device is detected (block 1034). If a registered device is not detected, the unregistered node can continue scanning for traffic. If, on the other hand, a registered device is detected, the unregistered node can detect traffic from the registered device and request registration as a regular node (block 1036). Registration can then be granted by a concentrator 102 or backbone node 104 (block 1038).

FIG. 11 is an exemplary embodiment of a flowchart that may be utilized in promoting a regular node, similar to the flowchart from FIG. 10. As illustrated in the nonlimiting example of FIG. 11, and discussed above, prior to seeking self-promotion, the regular node can receive registration requests from a predetermined number of unregistered devices (block 1132). Additionally, a determination is made whether the RSSI of a concentrator or parent node is greater than a predetermined value (block 1134). If these conditions are met, the regular node can send a request to the concentrator for promotion (block 1136). The concentrator can grant registration (promotion) as a backbone node by sending a registration message that includes a net plane ID (block 1138)

FIG. 12 is an exemplary embodiment of a flowchart that may be utilized in communicating data from a first node to a second node, similar to the flowchart from FIG. 1. As illustrated in the nonlimiting example of FIG. 12, a determination is made whether the first device A (FIGS. 6, 7, and 8) has previously communicated directly with a second device (block 1232). If a determination is made that the first device A has previously communicated with the second device, the first device A can send a message to the second device (block 1234). A determination can then be made whether an acknowledgement is received from the second device (block 1236). If an acknowledgement is received, the process can end. However, if an acknowledgement is not received, the first device A can send a message to a first backbone controller, indicating the ultimate recipient (block 1238). A determination can then be made whether the second device is part of a different network plane (block 1240). If the second device is not part of a second network plane, the message can be forwarded to the second device via a second backbone controller (block 1242). A determination can be made whether an acknowledgement is received from the second device (block 1244). If an acknowledgement is received, the process can end. If, on the other hand, no acknowledgement is received, the process can continue at block 1250.

If, at block 1240, the second device B is part of a different network plane (FIG. 8), a determination can be made whether the route to the different network plane is known (block 1246). If the route is known, the first device a can forward the message to the second backbone controller CB of the different network plane (block 1248). The process can then return to block 1244 to determine whether an acknowledgement is received. If, at block 1246, the route to the different network plane is not known, the first backbone controller CA can send a message to a network controller, requesting a route to the second backbone controller (block 1250). The network control can then determine route, store route, and send route to the first backbone controller (block 1252). The first backbone controller CA can receive, store, and send the route to the second backbone controller CB, and on to the second device B (block 1254). The second device B can receive the message, extract the route, calculate a reverse route from the determined route, and reply to the first device with an acknowledgement (block 1256).

The embodiments disclosed herein can be implemented in hardware, software, firmware, or a combination thereof. At least one embodiment disclosed herein may be implemented in software and/or firmware that is stored in a memory and that is executed by a suitable instruction execution system. If implemented in hardware, one or more of the embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One should note that the flowcharts included herein show the architecture, functionality, and operation of a possible implementation of software and/or hardware. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A method for advanced routing, comprising:
receiving a message from a first device at a first backbone controller, the message indicating a second device as a desired recipient;
sending the message to a network controller, the message including a request to a second backbone controller for a route to the second device, the second backbone controller related to the second device; and
receiving the route from the network controller.

2. The method of claim 1, further comprising storing the received route.

3. The method of claim 1, further comprising sending the received route to the second backbone controller.

4. The method of claim 1, wherein the second device is configured to receive the message.

5. The method of claim 4, wherein the second device is further configured to calculate a reverse route from the second device to the first device.

6. The method of claim 5, wherein the second device is further configured to send an acknowledgement to the first device via the calculated reverse route.

7. The method of claim 1, wherein the first device is located on a different network plane than the second device.

8. A system for advanced routing, comprising:
a first receiving component configured to receive a message from a first device at a first backbone controller, the message indicating a second device as a desired recipient;
a sending component configured to send the message to a network controller, the message including a request to a second backbone controller for a route to the second device, the second backbone controller related to the second device; and
a second receiving component configured to receive the route from the network controller.

9. The system of claim 8, further comprising a storing component configured to store the received route.

10. The system of claim 8, further comprising a sending component configured to send the received route to the second backbone controller.

11. The system of claim 8, wherein the second device is configured to receive the message.

12. The system of claim 11, wherein the second device is further configured to calculate a reverse route from the second device to the first device.

13. The system of claim 12, wherein the second device is further configured to send an acknowledgement to the first device via the calculated reverse route.

14. The system of claim 8, wherein the first device is located on a different network plane than the second device.

15. A computer readable storage medium for advanced routing, comprising:
first receiving logic configured to receive a message from a first device at a first backbone controller, the message indicating a second device as a desired recipient;
sending logic configured to send the message to a network controller, the message including a request to a second backbone controller for a route to the second device, the second backbone controller related to the second device; and
second receiving logic configured to receive the route from the network controller.

16. The computer readable storage medium of claim 15, further comprising storing logic configured to store the received route.

17. The computer readable storage medium of claim 15, further comprising sending logic configured to send the received route to the second backbone controller.

18. The computer readable storage medium of claim 15, wherein the second device is configured to receive the message.

19. The computer readable storage medium of claim 18, wherein the second device is further configured to calculate a reverse route from the second device to the first device.

20. The computer readable storage medium of claim 19, wherein the second device is further configured to send an acknowledgement to the first device via the calculated reverse route.
